(19) United States
(12) Patent Application Publication
(10) Pub. No.: US 2014/0108119 A1
(43) Pub. Date: Apr. 17, 2014

(54) MANAGEMENT OF MULTIPLE PAYMENT PROCESSES THROUGH USER EQUIPMENT

(71) Applicant: KT CORPORATION, Gyeonggi-do (KR)

(72) Inventors: Ra-Woon CHOI, Seoul (KR); Dong-Wan KIM, Seoul (KR); Min-Gu LEE, Gyeonggi-do (KR)

(73) Assignee: KT CORPORATION, Gyeonggi-do (KR)

(21) Appl. No.: 14/050,677

(22) Filed: Oct. 10, 2013

(30) Foreign Application Priority Data
Oct. 12, 2012 (KR) 10-2012-0113650

(51) Int. Cl. G06Q 30/02

(52) U.S. Cl. CPC G06Q 30/0226
USPC 705/14.27

(57) ABSTRACT

The disclosure is related to managing a plurality of payment processes of a consumer through user equipment. User equipment assigns priorities to the plurality of payment processes based on membership benefits, benefit requirements, and selection conditions. After assigning, the user equipment displays information on the plurality of payment processes with the assigned priorities.

### CROSS REFERENCE TO PRIOR APPLICATIONS

The present application claims priority under 35 U.S.C. §119 to Korean Patent Application No. 10-2012-0113650 (filed on Oct. 12, 2012), which is hereby incorporated by reference in its entirety.

### BACKGROUND

Lately, consumers have been able to make payments through various types of payment forms including payment cards. The payment card is a card that might be used by a consumer and accepted by a merchant to make a payment for purchasing a good or a service. The payment card includes a credit card, a debit card, an automated teller machine (ATM), a charge card, a stored-value card, a gift card, and so forth.

Due to advanced technologies of mobile devices, consumers frequently want make payments using a mobile payment service. The mobile payment service is also referred to as mobile money or a mobile wallet. The mobile payment service is a payment service that enables a consumer to make payment via a mobile device based on a predetermined financial regulation. Instead of making a payment with cash, a consumer can use a mobile device such as user equipment including a smart phone to pay for a wide range of services and goods. The mobile payment service might be a different application form of a payment card. For example, a payment card might be issued through a mobile device and digitally installed in the mobile device. Furthermore, many payment card companies (e.g., credit card companies) provide a digital version of a payment card that can be digitally installed in a mobile device and used as a mobile payment.

Due to various convenient features thereof, the mobile payment service has generally been popular among consumers. In general, a typical consumer carries a mobile device (e.g., a smart phone) with multiple payment means digitally installed therein. Due to keen competition, credit card companies and banks offer attractive membership benefits to consumers in order to encourage them to have and to use their corresponding process for payment. Such membership benefits might be a member discount, reward points, and a cash back bonus, which are given to consumers if the consumer uses their payment process to make a payment for goods and services at an affiliate member merchant or for predetermined goods or services eligible for receiving the membership benefits. However, in order to receive such membership benefits, the consumers must fulfill requirements such as a certain amount of money spent within a predetermined time period. Accordingly, a consumer might need to carefully select a given process for payment during a transaction to make the payment based on a membership benefit and a requirement thereof.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a consumer's multiple payment means might be managed through user equipment in order to obtain maximum membership benefits thereof.

In accordance with at least one embodiment, a method of user equipment might be provided for managing a plurality of payment processes belonging to a consumer to obtain associated membership benefits. The method might include computing a corresponding priority for each of the plurality of payment processes based on at least one of membership benefit information associated with a merchant, associated benefit requirement information, and selection condition information of the plurality of payment processes, assigning the computed priorities to the corresponding payment processes, and providing information on the plurality of payment processes with the assigned priorities to the consumer through a user interface displayed through an input/output circuit of the user equipment as a result of executing an application associated with the payment process and resident in the user equipment. The priority assigned to a payment process might indicate a measure of a membership benefit returned by employment of the payment process when the consumer uses the payment process to make a payment for a purchase of a good or a service from the merchant.

The method might comprises receiving a selection input corresponding to a selection of one of the plurality of payment processes from a user based on the assigned priorities of the plurality of payment processes and transmitting a payment request with information on the selected payment process to make a payment for a purchase of a good or a service from the merchant.

The method might comprise selecting, by a processor of the user equipment, one payment process assigned with a priority that indicates a maximum membership benefit returned to the consumer among the plurality of payment processes and transmitting a payment request with information on the selected payment process.

Prior to the computing, the method might comprise receiving information on the merchant from a merchant device upon a predetermined event, requesting the membership benefit information and the benefit requirement information, based on the received information on the merchant, from at least one of a service server coupled to the user equipment through a communication network, the merchant device, and a server associated with one of the merchant and each payment means of the consumer, and receiving the membership benefit information and the benefit requirement information from the at least one of the service server, the device of the merchant, and the server.

The predetermined event might be one of entering a predetermined area of the merchant, receiving a predetermined signal from the merchant device, and scanning a good or a service to be purchased from the merchant.

Prior to the computing, the method might comprise scanning a code pattern image posted at a certain area of the merchant, decoding the scanned code pattern image into information on the merchant, requesting the membership benefit information based on the information on the merchant to at least one of a service server coupled to the user equipment through a communication network, the device of the merchant, and a server associated with one of the merchant and each payment process of the consumer, and receiving the requested membership benefit information from the at least one of the service server, the device of the merchant, and the server.

Prior to the computing, the method might include scanning a code pattern image posted at a certain area of the merchant and decoding the scanned code pattern image into membership benefit information and benefit requirement information associated with the merchant.

Prior to the computing, the method might comprise detecting information on the plurality of payment processes based on information stored in the user equipment, providing the detected payment process information to the consumer through a user interface generated displayed through an input/output circuit of the user equipment as a result of executing an associated application stored in the user equipment, receiving set-up inputs, through the displayed user interface, corresponding to settings for selection conditions of the plurality of payment processes of the consumer, setting at least one of a user assigned priority, a user preferred membership benefit, and a target condition for satisfaction of an associated benefit requirement as the selection conditions of each one of the plurality of payment processes, and storing results of the set selection conditions in connection with the plurality of payment processes. The method might further include receiving information on at least one of the plurality of payment processes from the consumer through the user interface. The plurality of payment processes might be at least one of a payment process registered through the user equipment, a payment process digitally installed in the user equipment by downloading a digital version corresponding to the payment process from an associated server and installing the downloaded digital version, and a payment process issued from an associated server through the user equipment.

The computing might include selecting, from the plurality of payment processes of the consumer, each eligible payment process able to return membership benefits associated with the merchant based on at least one of the information on the merchant and the membership benefit information, applying a predetermined value to the corresponding priorities of the selected eligible payment processes, selecting, from one or more of the eligible payment processes, a preferred payment process able to return a membership benefit preferred by the consumer based on the selection condition information, determining associated benefit requirements of the preferred payment process based on the selection condition and sorting the preferred payment processes in an ascending order from the preferred payment process having a lowest degree of the determined benefit requirements to a highest degree of the determined benefit requirements, and applying different values decreasing in a descending order to corresponding priorities of the sorted preferred payment processes. One preferred payment process having a priority with a largest value returns the most membership benefit among the preferred payment processes if the consumer uses the one preferred payment process to make a payment to purchase a good or a service from the merchant.

In accordance with at least one embodiment, a method might be provided for managing, by user equipment, a plurality of credit cards belonging to a consumer to obtain maximum membership benefits. The method might include obtaining payment information on a purchase from a payment terminal of the merchant when the purchase is scanned by the payment terminal, wherein the payment information includes information on the purchase and the merchant, including the obtained payment information in a request message when requesting membership benefit information associated with the merchant, transmitting the request message to a service server, and receiving the requested membership benefit information from the service server, computing priorities of the plurality of credit cards based on the received membership benefit information and selection condition information of the plurality of credit cards and assigning the computed priorities to the plurality of credit cards, and providing information on the plurality of credit cards with the assigned priorities to the consumer through a user interface displayed through an input/output circuit of the user equipment as a result of executing an associated application stored in the user equipment. The priorities of the plurality of credit cards might indicate a measure of a membership benefit returned by a respective payment process when the respective payment process is used to make a payment for the purchase.

Prior to the obtaining, the method might include providing information on credit cards belonging to the consumer through a user interface displayed through an input/output circuit of the user equipment when executing an associated application stored in the user equipment, receiving a selection input of at least one of the plurality of credit cards and receiving set-up inputs for settings of selection conditions of the selected credit cards from the consumer through the displayed user interface, setting the selection conditions of the selected credit card based on the selection input and the set-up inputs, and storing results of the setting of the selection conditions as the selection condition information of the selected credit card.

When a price discount rate is set as a user preferred membership benefit and a predetermined target spending amount is set as a target condition for fulfilling benefit requirement as the selection condition information, the computing might include, for each one of the plurality of credit cards, obtaining a price discount rate of each credit card as the user preferred membership benefit, calculating a price of the purchase after the obtained price discount rate is applied, adding the calculated price with a previous spending amount (e.g., a spending amount of a previous month), and calculating a difference between the adding result and the target spending amount by subtracting the adding result from the target spending amount, storing the plurality of credit cards in a an ascending order based on the calculated difference of each credit card, and assigning corresponding priorities having descending values to the sorted credit cards. The computing might include assigning a lowest priority to a credit card when the credit card has the previous spending amount higher than the target spending amount.

When more than two credit cards have the same differences, the computing might include assigning a lower priority to one requiring a predetermined amount of reward points for using a membership benefit than priorities assigned to others not requiring the predetermined amount of reward points and assigning a higher priority to one credit card gaining a predetermined amount of reward points although a membership benefit is used for making a payment than to credit cards having priorities assigned not gaining the predetermined amount of reward points.

The method might further include receiving a selection input as a selection of one of the plurality of credit cards, the selection made by the consumer based on the assigned priorities of the plurality of credit cards and transmitting a payment request with information on the selected credit card to make a payment for the purchase.

In accordance with at least one embodiment, user equipment might be provided for managing a plurality of payment processes belonging to a consumer to obtain maximum membership benefits. The user equipment might be configured to receive payment information associated with a merchant and a purchase from a merchant device when the purchase is scanned by the device, to request membership benefit information and benefit requirement information associated with the merchant based on the received payment information to a service server coupled to the user equipment through a communication network and receive the membership benefit information and the benefit requirement information from the service server, to compute, by a processor of the user equipment, priorities of the plurality of payment processes based on the received membership benefit information, the received benefit requirement information, and selection condition information and assign the computed priorities to the plurality of payment processes, and to provide information on the plurality of payment processes with the assigned priorities through a user interface displayed through an input/output circuit of the user equipment as a result of executing an associated application stored in the user equipment. A priority of a payment process might indicate a degree of a membership benefit returned by the payment process when the consumer uses the payment process to make a payment for the purchase from the merchant.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates management of multiple payment processes through user equipment in order to obtain the membership benefits thereof accordance with at least one embodiment;

FIG. 2 shows user equipment for providing a management service for enabling a consumer to maximally obtain membership benefits of the consumer's payment process in accordance with at least one embodiment;

FIG. 3 illustrates operation for entering information on payment process and setting selection conditions of each payment process in accordance with at least one embodiment;

FIG. 4 illustrates operation of user equipment for enabling a consumer to obtain membership benefits of the consumer's payment process in accordance with at least one embodiment;

FIG. 5 illustrates an example of a graphic user interface providing initial payment process information in accordance with at least one embodiment;

FIG. 6 illustrates an example of a graphic user interface providing payment process information with priorities assigned based on membership benefit information and benefit requirement information associated with a merchant in consideration of selection condition information in accordance with at least one embodiment;

FIG. 7 illustrates another example of a graphic user interface providing payment process information with priorities assigned based on not only information associated with a merchant but also information associated with a good or a service to purchase in accordance with at least one embodiment; and

FIG. 8 illustrates an example of operation of user equipment for enabling a consumer to maximally obtain membership benefits of the consumer's payment process through user equipment in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with at least one embodiment, various types of payment process are managed through user equipment in order to maximally obtain membership benefits thereof. For example, multiple payment processes such as a credit card payment process, bank account debit payment process, or digital wallet payment process, might be registered at or digitally installed in user equipment such as a smart phone in connection with a related server. One of the multiple payment processes might be selected based on membership benefits and benefit requirements thereof. Furthermore, a consumer might be able to set selection conditions of each payment process. Based on the membership benefits, benefit requirements, and selection conditions thereof, user equipment selects one of the multiple payment processes, which will return the most membership benefits if the consumer uses the selected one to make a payment for a good or a service.

In order to select and use one payment process returning the most membership benefits among the multiple payment processes, a priority of each payment process is computed and assigned based on membership benefits, benefit requirements, and selection condition before a consumer makes a payment in accordance with at least one embodiment. Such a computed priority is displayed through user equipment in order to enable a consumer to select one of multiple payment process. Alternatively, the user equipment automatically selects one payment process having the highest priority from multiple payment processes to make a payment in accordance with at least one embodiment. Hereinafter, overall view of such management of multiple payment processes in accordance with at least on embodiment will be described with reference to FIG. 1.

FIG. 1 illustrates management of multiple payment means through user equipment in order to obtain a relative maximum of the membership benefits thereof accordance with at least one embodiment.

Referring to FIG. 1, user equipment 110 provides a consumer with a management service for managing multiple payment processes and selecting one returning the relative best benefits to the consumer among the multiple payment processes if the consumer uses the selected payment process to make a payment for a purchase (e.g., a hardware good, a digital good, and a service) in accordance with at least one embodiment. Such a management service might be provided through an application installed in user equipment 110 in connection with a related service server (e.g., service server 130). In order to provide such management service, user equipment 110 might be coupled to at least one of service server 130 and payment means server 140 through communication network 150. Through service server 130 and payment process server 140, user equipment 110 might collect information necessary for managing the multiple payment processes, such as membership benefit information and benefit requirement information. Furthermore, user equipment 110 might be coupled to payment terminal 120 of a merchant in a wireless link or a wired link. Through payment terminal 120, user equipment 110 might collect information (e.g., payment information) related to an affiliate merchant and/or a purchase. However, the present invention is not limited thereto.

As described, the management service enables a consumer to choose a payment process that returns the best benefits if the consumer uses the selected payment process for purchasing a good or a service. In order to provide such management service, user equipment 110 stores information on a plurality of payment processes that the consumer owns or subscribes to. As described, the payment process includes various types of payment cards such as a credit card, a debit card, an automated teller machine (ATM), a charge card, a stored-value card, a gift card, and so forth. In accordance with at least one embodiment, the consumer might register credit cards, debit cards, and gift cards at related service server 130 for the management service through an application installed in user equipment 110. User equipment 110 might include an installed dedicated application, which enables a consumer to register a plurality of payment cards for a management service at service server 130 or to enter information on the plurality of payment processes. Upon the registration or the entering the information thereof, user equipment 110 stores information on each payment process in a memory thereof. Furthermore, a digital version of a payment card process might be installed in user equipment 110 for a mobile payment service. For example, a related company of a payment card might provide a digital version (e.g., App) thereof to a consumer for a mobile payment service. In this case, a consumer might download such digital version of a payment process from a related server and digitally install the downloaded app in user equipment 110. In addition, such payment card might be issued through user equipment 110 from a related company such as a bank or a credit card company (e.g., payment means server 140). For example, a consumer applies a predetermined credit card through user equipment 110. Upon the approval of the application thereof, the consumer might be able to download a digital version of the predetermined credit card in user equipment 110 and installs the downloaded digital version thereof for a mobile payment service of the predetermined credit card. As described, user equipment 110 might already store information on each payment process.

In accordance with another embodiment, an application (e.g., a service management application) might automatically search payment processes issued through user equipment 110 or digitally installed in user equipment 110 through the application for the management service. User equipment 110 stores information on the searched payment processes in connection with the application for providing the management service.

The information related to the payment process (e.g., the payment process information) might include a name of a company issuing a respective payment process, a name of each payment process, an account number of a payment process, an expiration date of a payment process, a security code of a payment process, an Internet address of a server associated with a payment process (e.g., payment process server 140), and so forth. Furthermore, the information on the payment process might include information on affiliate merchants that are eligible to have membership benefits, or information on goods and/or services that are eligible to have membership benefits, awarded. Such information might be stored when each payment process is registered at or digitally installed in user equipment 110 and updated regularly. Alternatively, such information might be fetched from a related service (e.g., payment process server 140) upon a predetermined event, for example, right before a consumer makes a payment for a good or a service. In addition, the information on the payment process might include benefit requirement of each payment process. The present invention, however, is not limited thereto.

In order to select one payment process that returns the most membership benefits among multiple options, user equipment 110 obtains information on a merchant and/or a good or service to purchase from a related merchant before a consumer makes a payment thereof in accordance with at least one embodiment. For example, when a consumer wants to purchase a good (hardware or digital) and/or a service from affiliate merchant, user equipment 110 obtains payment information from a merchant. Such payment information might be received from a predetermined device such as payment terminal 120 or might be collected from a code pattern printed and posted at a certain area of an affiliate merchant. Such a code pattern may include a bar code, a quick response (QR) code, and so forth.

The payment information might include information on a merchant that provides a good or a service that a consumer wants to purchase. For example, the payment information includes a name of a merchant, an Internet address of a related server of the merchant, payment processes that are eligible to have membership benefits if a consumer purchases a good or a service from the merchant, and so forth. In addition, the payment information might include information a good or a service that a consumer wants to purchase such as, for example, a price thereof.

In order to obtain such payment information, user equipment 110 might request the payment information to payment terminal 120 through a wireless link established between payment terminal 120 and user equipment 110. Such wireless link might be established when user equipment 110 enters a predetermined area of a merchant, for example, a predetermined radius from payment terminal 120 of the merchant. Furthermore, payment terminal 120 might broadcast the payment information through a certain signal. In this case, user equipment 110 might receive such payment information when user equipment 110 enters a predetermined area of the merchant.

User equipment 110 might scan a predetermined code pattern posted at a certain area of a merchant. In this case, user equipment 110 might scan the predetermined code pattern and decode the scanned code pattern into the payment information including information on the merchant and/or the purchase. Furthermore, such code pattern image might be decoded into not only the payment information, but also membership benefit information and benefit requirement information associated with the merchant.

After obtaining the payment information from the merchant, user equipment 110 obtains information to compute priorities of the multiple payment processes based on the payment information. Such information might include membership benefit information, benefit requirement information, and selection information in accordance with at least one embodiment. The membership benefit information and benefit requirement information might be obtained from a server related to a respective merchant based on the payment information. The detailed description of the obtained information follows subsequently.

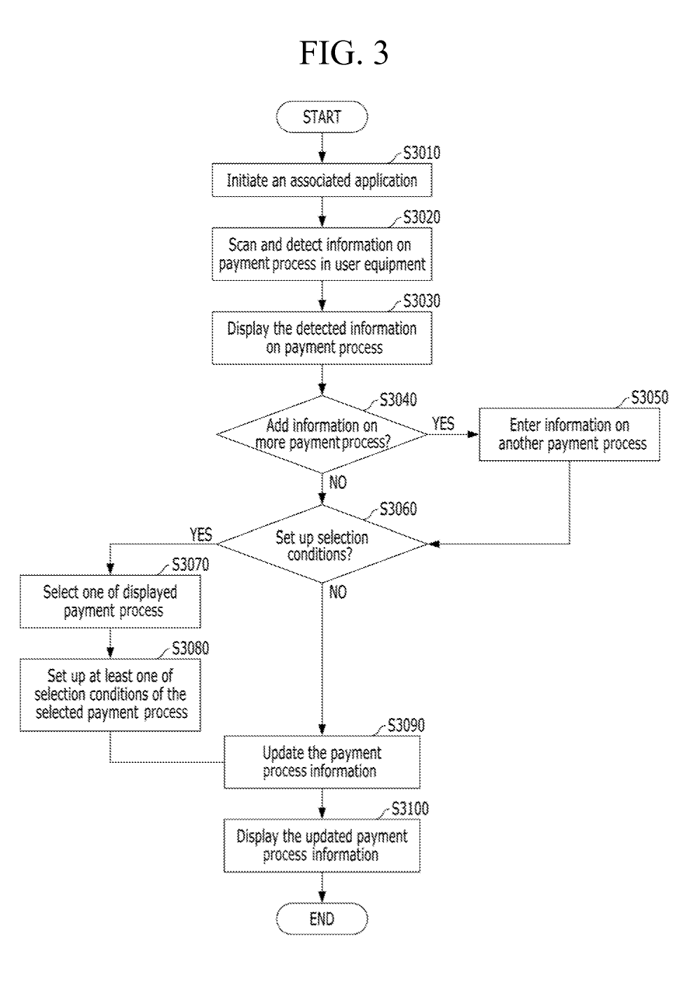

Based on the collected information (e.g., the payment information, the membership benefit information, the benefit requirement information, and the selection information), user equipment 110 computes a priority of each payment process and provides the computed priority to a consumer in order to enable the consumer to select one of the payment processes in accordance with at least one embodiment. For example, user equipment 110 assigns a higher priority to a payment process if the payment process returns more benefits than another one of the payment processes. Accordingly, if a consumer selects a payment process having the highest priority among multiple payment processes registered at or digitally installed in user equipment 110, the consumer might receive maximum membership benefits by using the selected payment process to make a payment. A method of computing and assigning a priority of each payment process based on the collected information will be described in more detail subsequently with reference to FIG. 3.

After computing and assigning the priorities to multiple payment processes, the priorities might be displayed through a display of user equipment 110 in association with the multiple payment processes. Such priorities and associated payment processes might be provided within a user interface (e.g., a graphic user interface or an application window) generated and displayed on the display of user equipment 110 in associated with the application.

In order to compute the priority of the payment process, user equipment 110 might consider i) information on membership benefits of each payment process in association with at least one of a merchant, a good or a service to purchase, ii) information on benefit requirements to receive membership benefits of each payment process, and iii) information on selection conditions of each payment process set by a consumer. As described, such membership benefit information and benefit requirement information might be obtained from a related server (e.g., service server 130 or payment means server 140) in response to a request from user equipment 110. The selection condition information might be set by a consumer through user equipment 110 and stored in user equipment 110.

The membership benefits of a payment process may include a price discount rate, a reward point, and a cash back bonus. Such membership benefits might be given to a consumer if the consumer uses an associated payment process for making a payment for a purchase of a merchant. For example, a first credit card company might give 10% discount on a price of a good or a service of a member merchant of the first credit card company if a consumer uses a first credit card to make a payment thereof.

The benefit requirements might indicate requirements for obtaining the membership benefit. For example, a first credit card company might give 1,000 reward points if a consumer uses 1,000 dollars through the first credit card to buy products of an associated affiliate merchant for a certain time period such as three consecutive months. In this case, the benefit requirement is spending 1,000 dollars in three consecutive months.

The selection condition indicates conditions for selecting one of the consumer's multiple payment processes. Such selection condition might be set by the consumer for each payment process. For example, the selection condition might be i) a user assigned priority of each payment process, ii) a preference of benefits (e.g., at least one of a price discount rate, a reward point, and a cash back bonus), and iii) a condition for fulfilling benefit requirements (e.g., a target spending amount of each payment process). The present invention, however, is not limited thereto. Beside the user assigned priority, the preference of benefits, and the target spending amount, another conditions might be set by a consumer to each payment process.

Based on the membership benefit information, the benefit requirement information, and the selection condition information, user equipment 110 might compute a priority of each payment process, assign the computed priority thereto, and provide the computed priority with each payment process to the consumer. For example, a consumer has first to third payment processes and wants to purchase a smart phone from a Pear store that is an affiliate merchant of the first payment process (e.g., a first credit card). Since the Pear store is the affiliate merchant of the first payment process, the consumer will have 10% discount on the price of the smart phone if the consumer uses the first payment process to make a payment for the smart phone.

In this case, user equipment 110 of the consumer obtains payment information of the Pear store and the smart phone from payment terminal 120 of the Pear store. User equipment 110 transmits a request for membership benefit information and benefit requirement information associated with the Pear store and/or the smart phone to service server 130 based on the obtained payment information through communication network 150.

User equipment 110 obtains the membership benefit information and the benefit requirement information, which are associated with the Pear store and/or the smart phone, from service server 130 based on the information on the Pear store and the smart phone included in the payment information. The membership benefit information might include information on payment process eligible to have member benefits such as member discounts, reward points, and cash bonus. For example, the membership benefit information indicates that a first payment process might be eligible to have membership benefits such as 15% member discount. The associated benefit requirement information indicates requirements to have such membership benefits, which indicates that a consumer must spend more than 1,000 dollars for three consecutive months.

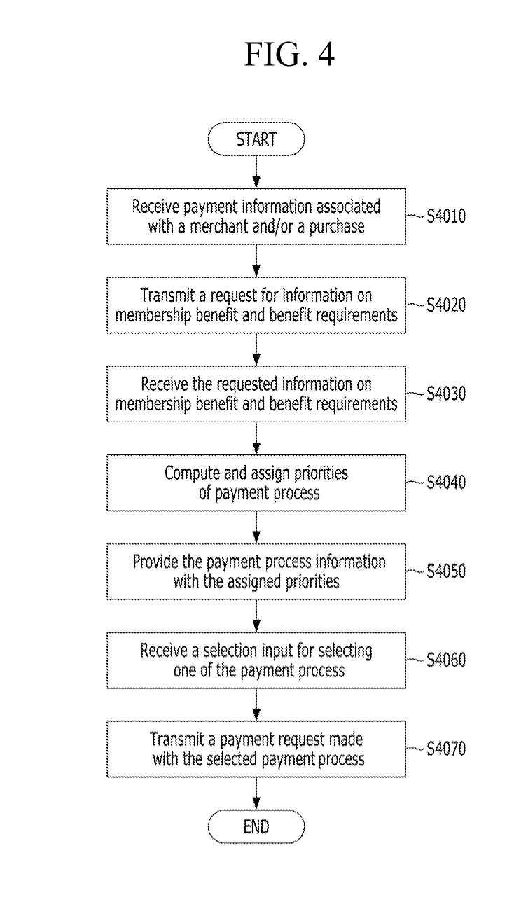

Based on the membership benefits information, the benefit requirement information, and the selection conditions, user equipment 110 computes a priority of each payment processes in accordance with at least one embodiment. For example, a higher priority might be given to a payment process that can return more membership benefits to the consumer. Since the membership benefits information associated with the Pear store indicates that the first payment process is eligible to have 15% discount on the price of the smart phone, user equipment 110 might assign the higher priority to the first payment process than other available payment processes. Among payment processes having the same membership benefits, one having less benefit requirements might be assigned with higher priority than others having more benefit requirements. In addition, the user assigned priority or the user preference of the membership benefit included in the selection condition information might be considered to compute the priorities of the payment processes. Such method of computing and assigning priorities of payment processes will be described in detail with reference to FIG. 4.

User equipment 110 provides such computed and assigned priorities with the multiple payment processes to the consumer through an associated user interface (i.e., an application window or a graphic user interface) generated by an associated application and displayed on a display of user equipment 110. The consumer selects one having the highest priority among the multiple payment processes through the user interface. The present invention, however, is not limited thereto. In accordance with another embodiment, user equipment 110 might automatically select a payment process having the highest priority among the multiple payment processes of the consumer to make a payment for a purchase.

As described above, user equipment 110 is coupled to payment terminal 120 of a merchant through a wireless link when user equipment 110 enters a predetermined radius from payment terminal 120. That is, payment terminal 120 provides payment information on a merchant and/or a purchase to user equipment 110. Such payment information might be provided to user equipment 110 in response to a request from user equipment 110, but the present invention is not limited thereto. Payment information might be provided without a request from user equipment 110. For example, when an employee scans a bar code of a good with payment terminal 120, corresponding payment information might be transmitted to user equipment 110. For another example, such payment information might be provided to user equipment 110 when user equipment 110 enters a certain area of the merchant. The payment information includes at least one of an identifier of the merchant, an Internet address of a server containing membership benefit information and/or benefit requirement information related to the merchant, and so forth. Furthermore, the payment information might include information on a good or a service that a consumer wants to buy.

User equipment 110 might transmit a request for membership benefit information and benefit requirement information to service server 120 by including the payment information into the request. The present invention, however, is not limited thereto. User equipment 110 might obtain such information directly to a server associated with a merchant or a good. Based on the payment information, user equipment 110 might be aware of a server related to a merchant and/or a product and request the server to provide associated membership benefit information and benefit requirement information.

Payment terminal 120 receives a payment request from user equipment 110 with a payment process selected by a consumer and transmits the payment request made through the selected payment process to a server related to the selected payment process, for example, payment process server 130. That is, after a consumer selects a payment process based on the priorities of the payment processes and makes a payment through the selected payment process, payment terminal 120 receives the payment request from user equipment 110 and performs a payment processing procedure in connection with a server associated with the selected payment process (e.g., payment process server 140). For example, payment terminal 120 may include a point of sale (POS) terminal, a cash register device, a computer having a payment processing function, and so forth.

The payment request is described as being processed through payment terminal 120, but the present invention is not limited thereto. User equipment 110 might transmit such payment request made with a selected payment process directly to a payment server associated with the selected payment process.

Service server 130 is a server for providing a management service that enables a consumer to maximally obtain membership benefits of the consumer's payment means through user equipment 110 in accordance with at least one embodiment. Such a service server 130 is coupled to user equipment 110 through communication network 150. Service server 130 provides applications (e.g., App) and information for providing the management service in response to requests from user equipment 110.

For example, service server 130 might store an application (e.g., App) for the management service and provide such an application to user equipment 110 in response to a request from user equipment 110. Particularly, user equipment 110 accesses service server 130, downloads the application (e.g., App), and installs the downloaded application for providing the management services. After installation, the installed application is initiated by a consumer or automatically upon a predetermined event. The predetermined event might include entering a predetermined area of a merchant, receiving signals from payment terminal 120, and scanning a predetermined code pattern posted on a predetermined area of a merchant. Through the initiated application, user equipment 110 provides the management service, but the present invention is not limited thereto.

Furthermore, service server 130 provides information on membership benefits associated with a merchant and/or a purchase to user equipment 110 in response to a request from user equipment 110. Service server 130 also provides information on benefit requirements associated with the membership benefits. For example, service server 130 might store the membership benefit information and the benefit requirement information associated with at least one of merchants and payment processes and provides the stored membership benefit information and benefit requirement information to user equipment 110 in response to a request from user equipment 110. The present invention, however, is not limited thereto. For example, service server 130 might request such membership benefit information and benefit requirement information to a server associated with a merchant or payment means instead of storing such information. Such a server associated with a merchant or payment process might be payment process server 140.

Service server 130 was described as performing the management service in cooperation with user equipment 110, but the present invention is not limited thereto. For example, user equipment 110 might provide such management service to a consumer independently after downloading an application from service server 130. User equipment 110 might obtain membership benefit information and corresponding benefit requirement information directly from a server related to an affiliate merchant or a payment process based on the payment information obtained from a merchant.

Payment process server 140 is a server associated with each payment process. For example, payment process server 140 might be a server operated by a payment process company, such as a credit card company or a bank. Payment process server 140 is coupled to payment terminal 120 and process a payment process procedure associated with a payment made through user equipment 110 in cooperation with payment terminal 120.

For example, payment process server 140 might process a payment request from payment terminal 120 based on information of a payment process used to make a corresponding payment. Then, payment process server 140 might return an approval message or a denial message to payment terminal 120 as a processing result.

Furthermore, payment process server 140 might provide membership benefit information and benefit requirement information associated with a payment process in response to a request from at least one of service server 130 and user equipment 110, but the present invention is not limited thereto.

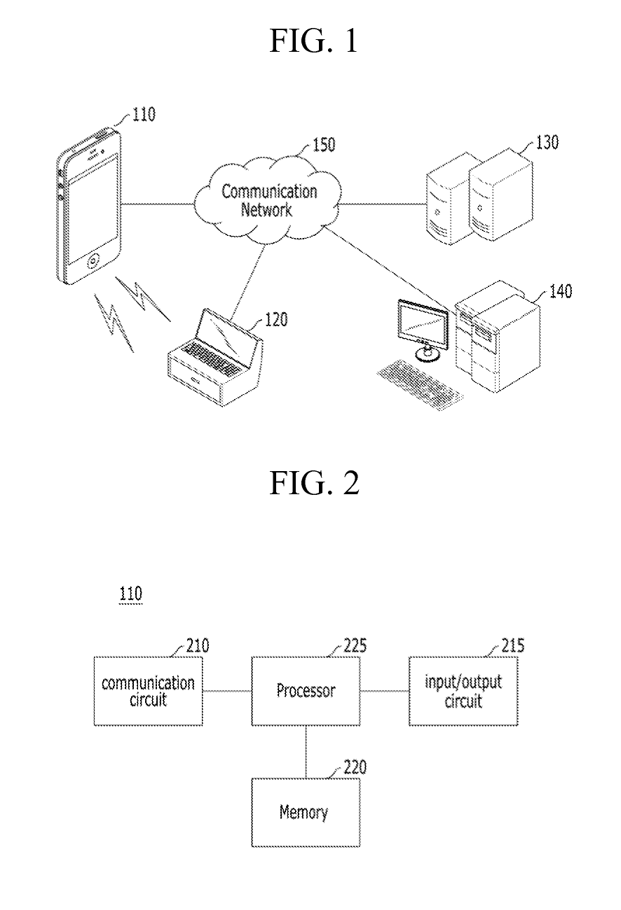

As shown in FIG. 1, user equipment 110 provides a management service for enabling a consumer to maximally obtain membership benefits of the consumer's payment process in accordance with at least one embodiment. In order to enable a consumer to have such maximum membership benefits, user equipment 110 computes a priority of a consumer's each payment process based on membership benefits, benefit requirements, and selection conditions thereof. After computation, user equipment 110 provides the computed priorities of the payment means to the consumer when the consumer wants to use one of the payment processes for buying a good or a service from a merchant. The consumer might select a payment process having the highest priority to buy a good or a service. In this way, the consumer might maximally obtain membership benefits of the payment process. For example, user equipment 110 sorts the payment processes based on the computed priorities thereof and display the sorted payment processes on a screen of user equipment 110. Hereinafter, such user equipment 110 will be described in detail with reference to FIG. 2.

FIG. 2 shows user equipment for providing a management service for enabling a consumer to maximally obtain membership benefits of the consumer's payment process in accordance with at least one embodiment.

Referring to FIG. 2, user equipment 110 includes communication circuit 210, input/output circuit 215, memory 220, and processor 225. Communication circuit 210 transmits and receives data to or from other entities through communication network 150. For example, communication circuit 210 communicates with other entities including payment terminal 120, service server 130, and payment process server 140 using various types of communication schemes in order to obtain information required for providing the management service in accordance with at least one embodiment.

For convenience and ease of understanding, user equipment 110 is illustrated as having one communication circuit, but the present invention is not limited thereto. For example, user equipment 110 might include more than two communication circuits each employing different communication scheme. Such communication circuits might include a short distance communication circuit for short distance communication, such as a near field communication (NFC) and a mobile communication circuit for long range communication through a mobile communication network, such as long term evolution (LTE) communication or wireless data communication (e.g., WiFi). Through the short distance communication circuit, user equipment 110 might communicate with payment terminal 120. Through the mobile communication circuit, user equipment 110 might communicate with service server 130 and payment process server 140 through various types of communication networks.

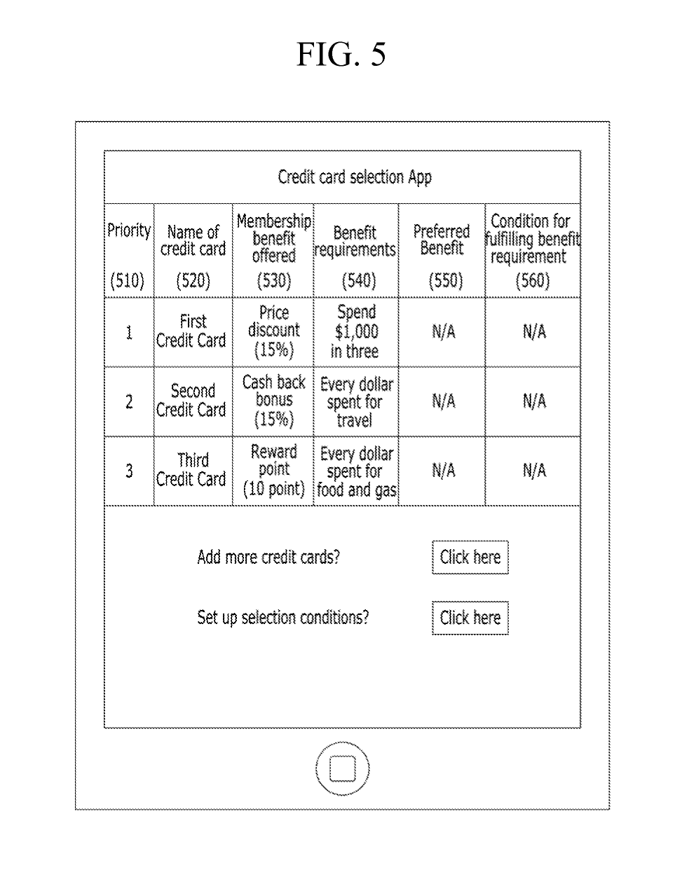

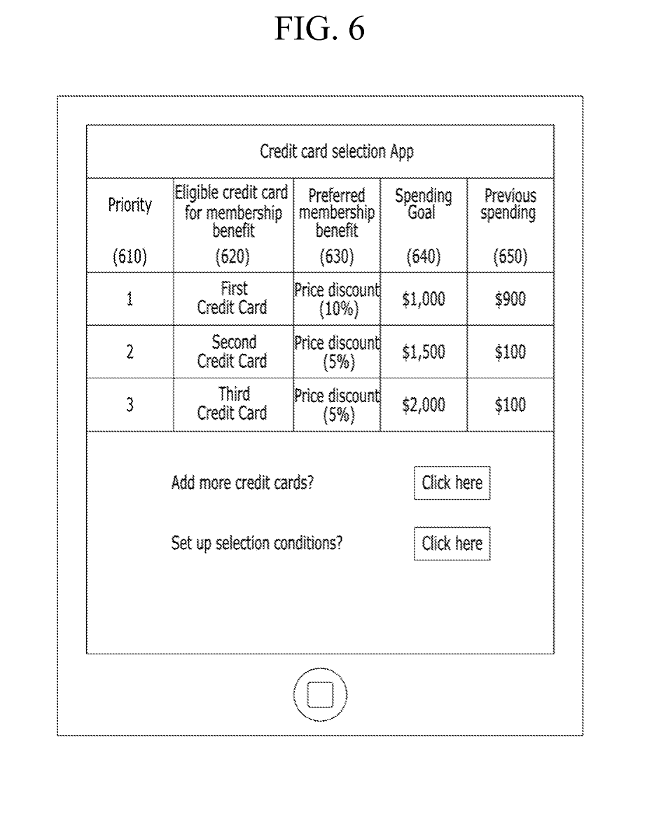

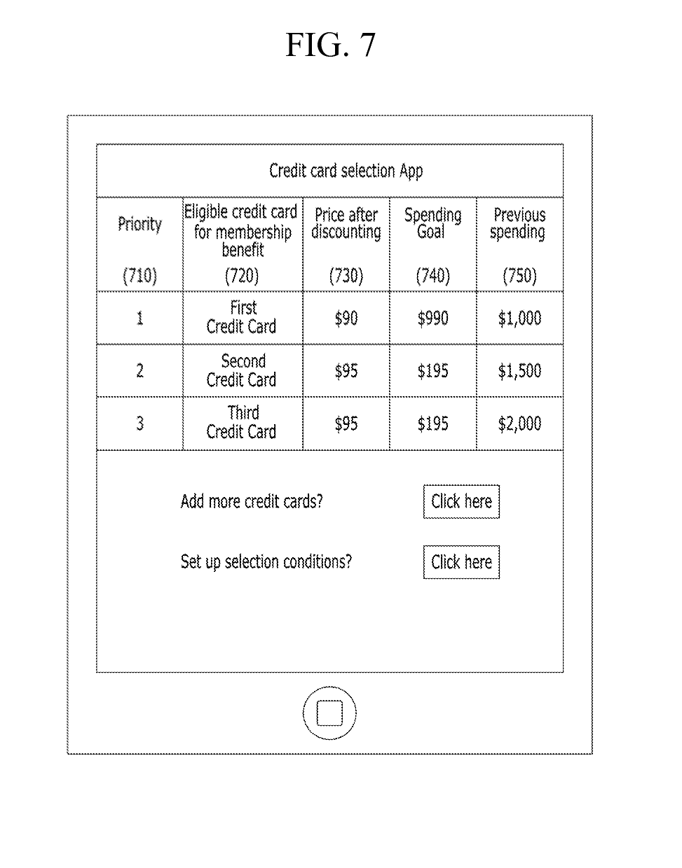

Input/output circuit 215 might receive various types of inputs from a user (e.g., a consumer) and output a result of processing based on the received inputs. For example, input/output circuit 215 might receive various types of commands for controlling constituent elements of user equipment 110 from a user and display various types of information generated as a result of processing the received inputs in various formats. Particularly, input/output circuit 215 receives touch inputs from a consumer through a predetermined graphic user interface displayed on input/output circuit 215. Furthermore, input/output circuit 215 outputs the result of processing based on the received touch input through the predetermined graphic user interface. For example, input/output circuit 215 might display a graphic user interface showing information about a payment process as shown in FIG. 5, FIG. 6, and FIG. 7.

Input/output circuit 215 might include a display panel for displaying information, such as a liquid crystal display, and a touch sensor panel for sensing touch inputs. Such input/output circuit 215 might be referred to as a touch screen. Since such a touch screen is well known in the art, the detailed descriptions thereof are omitted herein.

In FIG. 2, user equipment 110 is illustrated as having input/output circuit 215 as one integrated input/output circuit, but the present invention is not limited thereto. User equipment 110 might include various types of input circuits (e.g., keypad, buttons, and sensors) separated from output circuits (a flat panel display).

Memory 220 stores various types of data including operating system programs for controlling user equipment 110 and at least one application necessary for providing the management service through user equipment 110 in accordance with at least one embodiment. For example, memory 220 might store an application for managing payment processes to obtain relatively maximum membership benefits provided through a consumer's payment process.

Furthermore, memory 220 stores information associated with providing the management service, which might be received from other entities (e.g., service server 130 and payment process server 140) through communication circuit 210. For example, memory 220 stores membership benefit information and benefit requirement information of each payment process, which are obtained from other entities through communication circuit 210. Memory 220 also stores information on selection conditions which are associated with each payment process and set by a user (e.g., a consumer).

In addition, memory 220 stores information on a consumer's multiple payment means, also referred to as payment means information. Such payment means might be issued through user equipment 110, registered at service server 130 through user equipment 110, and digitally downloaded from an associated server (e.g., payment process server 140) and digitally installed in user equipment 110 as a digital version implementing a payment process.

Memory 220 is described as one memory circuit for storing payment process information, membership benefit information, benefit requirement information, and selection condition information together as well as other information such as applications and the operating system data, but the present invention is not limited thereto. For example, memory 220 might include a plurality of internal and external memory circuits in order to store payment process information, membership benefit information, and/or benefit requirement information separately from the other information such as applications and operating system data. In general, the information associated with payment processes is required high security protection. Accordingly, such information might be stored in an internal memory circuit separated from memory circuits storing the other information such as applications and operating system data or might be stored in a detachable external memory circuit such as a secure digital (SD) memory card.

Processor 225 is a central processing circuit that controls constituent elements of user equipment 110, such as communication circuit 210, input/output circuit 215, and memory 220, in accordance with at least one embodiment. Furthermore, processor 225 performs operations for managing multiple payment processes to maximally obtain membership benefits thereof based on user inputs received through input/output circuit 215 and information received through communication circuit 210 and/or stored in memory 220 in accordance with at least one embodiment.

For example, processor 225 executes, in response to a user input received through input/output circuit 215, an application for providing a management service for enabling a consumer to maximally obtain membership benefits of the consumer's multiple payment processes. As a result of executing the application, a predetermined user interface might be displayed on input/output circuit 215. Through such a predetermined user interface displayed on input/output circuit, a user (e.g., a consumer) might be able to perform various operations related to obtaining the maximum membership benefits of the payment processes. For example, through the predetermined user interface, the user might i) identify a payment process that the user can use to make a payment for a desired good or service, ii) identify a priority of each payment process, iii) select a payment process having the highest priority, iv) check information on each payment process such as membership benefits and benefit requirements thereof, v) set a selection condition of each payment process, vi) register payment processes at user equipment 110 or service server 130, vii) digitally install payment processes in user equipment 110, and viii) enter information on a consumer's existing payment process. However, the present invention is not limited thereto.

Processor 225 also performs operations related to computing and assigning priorities of a user's multiple payment process based on information on membership benefits, benefit requirements, and selection conditions. After computing and assigning the priorities, processor 225 performs operations related to displaying the computed and assigned priorities with the multiple payment processes through the predetermined user interface on input/output circuit 215. Furthermore, processor 225 performs operations related to receiving a selection input for selecting one of the displayed payment processes from a consumer and transmitting a payment request to payment terminal 120 or to a related payment server.

As described, user equipment 110 enables a consumer to obtain relative maximum membership benefits of the consumer's payment processes in accordance with at least one embodiment. In order to provide such service, user equipment 110 enables a consumer to register or enter information on the consumer's payment process through a user interface generated by executing an associated application through processor 225 and displayed on input/output circuit 215. Furthermore, user equipment 110 enables a consumer to set selection conditions of the consumer's payment process through the associated user interface. Such operations of user equipment 110 will be described in detail with reference to FIG. 3.

FIG. 3 illustrates operation for entering information on payment processes and setting selection conditions of each payment process in accordance with at least one embodiment.

Referring to FIG. 3, an associated application (e.g., App) is initiated in response to a user input at step S3010. For example, a user activates the associated application displayed as an icon within a general graphic user interface (e.g., a home screen or a default graphic user interface) of user equipment 110. The associated application might be downloaded from service server 130 and installed in user equipment 110 for a payment process management service that enables a consumer to maximally obtain membership benefits of the consumer's payment process (e.g., credit cards).

At step S3020, upon the initiation of the application, information on a payment process, stored in user equipment, is scanned and detected automatically or in response to a predetermined event. Such a predetermined event might be a user input made through a user interface displayed on input/output circuit 215 as a result of initiating the application.

Such information on payment processes might be information stored in memory 220 as a result of i) registering a predetermined payment process at one of user equipment 110 or service server 120 for the payment process management service, ii) issuing a payment process through user equipment 110 in connection with a related server such as payment process server 140, or iii) installing a digital version of a payment process in user equipment 110.

The operation of FIG. 3 is described as scanning and detecting information of a payment process upon the initiation of the application, but the present invention is not limited thereto. Such operation of step S3020 might be omitted. In this case, upon the initiation of the application, user equipment 110 fetches information on payment processes stored in predetermined sectors of memory 220, which are assigned to the application or the payment process management service. Then, user equipment 110 displays the fetched information on the payment process through input/output circuit 215 within the user interface of the application in the following step S3030.

At step S3030, the detected information of the payment process is displayed within the user interface of the application. For example, user equipment 110 displays the detected information of the payment process within the user interface of the application as shown in FIG. 5. Such payment process information might include a name of each payment process, a priority of each payment process for selection to make a payment, and predetermined details of each payment process, for example, initial selection conditions thereof.

At step S3040, determination is made as to whether a user (e.g., a consumer) wants to add information on another payment process. For example, user equipment 110 might inquire through the user interface of the application whether the user desires adding information of more payment processes that the user has access to.

If a user wants to add information on more payment processes (Yes—S3040), information on new payment processes is entered through the user interface of the application at step S3050.

If a user does not want to add information on more payment processes (No—S3040), determination is made whether to set up selection conditions for at least one of payment process at step S3060. As described, the selection conditions might be i) a user assigned priority of each payment process, ii) a preference of benefits (e.g., at least one of a price discount rate, a reward point, and a cash back bonus), and iii) a target condition for fulfilling benefit requirements (e.g., a target spending amount of each payment process). Through the user interface of the application, the user is able to set up the selection conditions.

The user assigned priority of each payment process might be an initial priority for selecting one of the user's available payment processes. When the user wants to use a first payment process more than second and third payment processes, the user sets up a priority of the first payment process higher than the second and third payment processes. The preference of benefits indicates one of membership benefits that the user prefers. That is, when the user wants to use a payment process offering a higher price discount rate more than another payment process returning a reward point or a cash bonus, the user sets the preference of benefits as a price discount rate. The condition for fulfilling benefit requirements indicates an objective for fulfilling benefit requirements. For example, if a benefit requirement of a first payment process to have a higher price discount is spending 1,000 dollars for a certain period time, the user sets the condition for fulfilling benefit requirements as 1,000 dollars.

If a user does not want to set up selection conditions (No—S3060), the payment means with default information are displayed within the user interface of the application at step S3100. For example, user equipment 110 might display information on the user's payment processes within the user interface of the application with default priorities. That is, the preference of benefits and the condition for fulfilling benefit requirements might be not displayed with the information on the user's payment process or might be displayed with default values thereof and with the information on the user's payment process.

If a user wants to set up selection conditions (Yes—S3060), at least one of payment process displayed within the user interface of the application is selected at step S3070. For example, user equipment 110 might display a user interface that enables the user to select at least one of payment process and to set up the selection conditions. Through such interface, the user selects one of payment process to set selection condition thereof.

At step S3080, selection conditions of the selected payment process are set up and the set selection conditions are stored in connection with the selected payment process in memory 220. For example, through the user interface, the user sets up one of the user assigned priority, the preference of the benefits, and the condition for fulfilling the benefit requirements of the selected payment process. Such set selection conditions of the selected payment process are stored in memory 220 of user equipment 110.

At step S3090, the payment means information is updated based on the result of adding the new payment process and the result of the setting the selection conditions of the selected payment process and stored in memory 220. For example, user equipment 110 updates the payment process information with information of the added payment process and the set selection conditions of the selected payment process.

At step S3100, the updated payment process information is displayed within the user interface of the application. For example, user equipment 110 might display the payment process information as shown in FIG. 6. Such displayed payment process information might be initial payment process information before computing and assigning priorities of payment processes based on additional information associated with a merchant or a good to purchase. Based on such initial payment process information displayed within the user interface of the application, the user (e.g., a consumer) is able to select one of the user's payment processes to obtain relative maximum membership benefits without obtaining additional information such as membership benefit information and benefit requirement information from service server 130. When the user wants to buy a good or a service from a merchant not offering membership benefits or when the user wants to buy a good or a service not eligible to have membership benefits, such initial payment process information with the initial selection conditions might be used to obtain relatively maximum initial benefits of the user's payment process in accordance with at least one embodiment.

After entering information on a user's payment process and setting selection conditions thereof, user equipment 110 computes and provides priorities of the user's payment process based on additional information associated with a merchant or a good when the user tries to buy the good from the merchant. Such operation of user equipment 110 will be described with reference to FIG. 4.

FIG. 4 illustrates operation of user equipment for enabling a consumer to obtain relative maximum membership benefits of the consumer's payment process in accordance with at least one embodiment.

Referring to FIG. 4, payment information associated with a merchant and/or a purchase is obtained at step S4010. For example, when a consumer with user equipment 110 enters a certain area of a merchant, user equipment 110 receives payment information from a predetermined device of the merchant (“merchant device”). Such predetermined device might be embodied as payment terminal 120. The payment information includes information on at least one of the merchant and goods or services that the merchant sells. For example, the payment information includes a name of a merchant and details of goods and services sold by the merchant. Further, the payment information might include information on an Internet address of a related server associated with the merchant or a related server associated with goods and services the merchant offers, and details of certain payment processes that are eligible to have membership benefits if a consumer purchases a good or a service from the merchant using such certain payment processes. Such payment information might be broadcast from the predetermined merchant device in a certain message format recognizable by user equipment 110.

The payment information is described as received from the predetermined merchant device (e.g., payment terminal 120), but the present invention is not limited thereto. For example, the payment information might be obtained by scanning a code pattern image posted at a certain area of the merchant. The code pattern image might be a bar code or a quick response (QR) code. In this case, user equipment 110 scans the code pattern image and decodes the scanned code pattern image into the payment information.

Furthermore, the payment information might be transmitted to user equipment 110 when an employee of the merchant scans a good or a service that the consumer wants to buy with payment terminal 120. In this case, the payment information includes information on a price of a certain good or service that the consumer wants to buy as well as the information on the merchant. Such information on the price of the certain good or service might be used to compute priorities of payment processes in consideration of benefit requirements.

At step S4020, a request for membership benefit information and benefit requirement information is transmitted to a related server. For example, upon the receipt of the payment information, user equipment 110 extracts the information on the merchant and requests membership benefit information and/or benefit requirement information associated with the merchant. Particularly, user equipment 110 requests service server 130 for the membership benefit information and/or the benefit requirement information associated with the merchant or the goods or the services offered by the merchant. The present invention, however, is not limited thereto. User equipment 110 might directly request to servers related to the merchant for the membership benefit information and/or the benefit requirement information instead of service server 130. Since the payment information might include the Internet address of the merchant, user equipment 110 accesses such a server of the merchant and obtains the membership benefit information and the benefit requirement information therefrom. Furthermore, user equipment 110 might obtain membership benefit information and benefit requirement information associated with a good or a service by directly communicating with a server related to the good or the service.

At step S4030, the membership benefit information and the benefit requirement information are received. For example, user equipment 110 receives the membership benefit information and the benefit requirement information associated with the merchant from service server 130. Such membership benefit information includes information on payment processes eligible to have membership benefits such as price discount rates, reward points, cash back bonus, and so forth. Furthermore, the membership benefit information includes information on membership benefits associated with the eligible payment processes. The benefit requirement information includes information on requirements to have the associated membership benefits.

The membership benefit information and the benefit requirement information are described as being received from service server 130, but the present invention is not limited thereto. Such information might be obtained from the predetermined device (e.g., payment terminal 120) of the merchant. Furthermore, user equipment 110 might obtain information on payment processes eligible to have membership benefits directly from the predetermined device (e.g., payment terminal 120) of the merchant.

At step S4040, priorities of the consumer's payment processes are computed and assigned based on the membership benefit information, the benefit requirement information, and the selection condition information associated with each payment process. For example, user equipment 110 computes priorities of the consumer's payment processes based on the membership benefit information, the benefit requirement information, and the selection condition information. Particularly, user equipment 110 assigns a higher priority to a payment process that returns more membership benefits with less benefit requirements to the consumer if the consumer uses the payment process to make a payment for a good or a service of the merchant. When user equipment 110 computes the priorities of the consumer's payment processes, user equipment 110 considers the benefit preference and the conditions for fulfilling benefit requirements, which are set in the selection condition for each payment process, as well as the membership benefits and the benefit requirements of each payment process.

There are many methods for computing and assigning the priorities of the consumer's payment processes in accordance with at least one embodiment. For convenience and ease of understanding of the present embodiments described herein, an exemplary method for computing and assigning the priorities will be described. The exemplary method computes and assigns a priority of a credit card use as a payment process in consideration of a price discount set as a user preference benefit, and a required spending amount as a benefit requirement. The present invention, however, is not limited thereto.

First, user equipment 110 determines which one of a consumer's credit cards is eligible to obtain a predetermined membership benefit, which might be set as a user preference benefit in the selection condition. For example, user equipment 110 determines which the consumer's first to third credit cards are eligible to have a price discount if either of the first to third credit cards are used to make a payment for a desired good in a merchant.

If the first credit card is eligible to have the price discount, a predetermined value is added to a priority of the first credit card. The predetermined value might be an integer number of 1. If not, no value is added to the priority of the credit card. In case of the first and second credit cards are eligible to have the price discount and the third credit card is not eligible, user equipment 110 adds 1 to the priorities of the first and second credit cards and does not add any value to the priority of the third credit card.

Second, user equipment 110 determines which eligible payment process has less benefit requirements. For example, when the first credit card requires $1,000 spending in three consecutive months and the second credit card requires $1,500 spending in the three consecutive months as the benefit requirement, user equipment 110 adds more value to the priority of the first credit card than the second credit card. For example, user equipment 110 might add an integer value of 2 to the priority of the first credit card and add an integer value of 1 to the priority of the second credit card. In this way, the first credit card, the second credit card, and the third credit card have the different priorities. For example, the priority of the first credit card is 3, the priority of the second credit card is 2, and the priority of the third credit card is 0. The first credit card has the highest priority because the first credit card offers the highest price discount rate.

When two or more credit cards have the same priority, other information associated with the merchant, the goods or services, and the payment process might be considered to compute the priorities of credit cards. For example, other membership benefits of each credit card might be considered when two or more credit cards have the same priority. When the first and second credit cards have the same priorities, other membership benefits of the first and second credit cards are considered in order to add more values to the priorities of the first and second credit cards. For example, user equipment 110 can determine whether a certain amount of reward points will be subtracted if the first credit card or the second credit card is used to have the price discount benefit. Furthermore, user equipment 110 can determine whether a certain amount of cash back points will be given if the first credit card or the second credit card is used to buy a good while buying the good with the price discounted using the price discount benefit. Based on such determination result, the priorities of the first and second credit cards are adjusted.

As another example, the priorities might be calculated as follows. User equipment 110 selects, from the plurality of payment processes of the consumer, eligible payment processes that are eligible to return membership benefits associated with the merchant based on at least one of the information on the merchant and the membership benefit information. User equipment 110 applies a predetermined value (e.g., 1) to priorities of the selected eligible payment processes. User equipment 110 selects, from the eligible payment processes, preferred payment processes that return a membership benefit preferred by the consumer based on the selection condition information. User equipment 110 applies the predetermined value to priorities of the selected preferred payment processes.

Then, user equipment 110 determines associated benefit requirements of the preferred payment process based on the selection condition and sorts the preferred payment processes in an ascending order from the preferred payment process having a lowest degree of the determined benefit requirement to a highest degree of the determined benefit requirements. User equipment 110 applies different values that decrease in a descending order to priorities of the sorted payment processes, respectively. Accordingly, one having a priority with a largest value returns most membership benefit among the preferred payment processes if the consumer uses the one to make a payment to purchase a good or a service from the merchant.

At step S4050, information on the consumer's payment processes (e.g., payment means information) are provided with the corresponding priorities. For example, user equipment 110 displays the information on the consumer's payment means with the assigned priorities within a graphic user interface generated as a result of executing an application (e.g., a credit card selection App) for a payment means management service. Such graphic user interfaces are shown in FIG. 5, FIG. 6, and FIG. 7. As shown in FIG. 5, FIG. 6, and FIG. 7, such graphic user interface shows a priority of each payment process, a name of each payment process, membership benefits of each payment process, benefit requirements of each payment process, a condition for fulfilling a benefit requirement, and so forth. Such shown information might be obtained from the membership benefit information, the benefit requirement information, and the selection condition information of each payment process.

At step S4060, a selection input for selecting one of the payment processes is received. For example, user equipment 110 receives a selection input made one of the consumer's payment processes for selecting one returning the maximum membership benefit. Such selection input might be made by a consumer to select a payment process having the highest priority. Furthermore, the selection input might be made by a consumer after carefully considering other factors of each payment process.

The selection of one of the payment processes is described as being performed based on the selection input made by the consumer, but the present invention is not limited thereto. Such selection might be made automatically by user equipment 110 to select a payment process having the highest priority among the consumer's multiple payment processes.

At step S4070, a payment is made using the selected payment process and a payment request is transmitted. For example, user equipment 110 makes a payment using the selected payment process and transmits a payment request including information on the selected payment process to payment terminal 120 of the merchant. In response to the payment request, payment terminal 120 performs a payment procedure to make a payment made through the selected payment process based on the priority.

As described, user equipment 110 provides the assigned priorities of the consumer's payment process within a graphic user interface generated as a result of executing an associated application and displayed through input/output circuit 215 in accordance with at least one embodiment. Such graphic user interface shows various types of information with the assigned priorities of the payment processes in order to enable the consumer to choose one returning the most membership benefits from the consumer's multiple payment processes. Hereinafter, such graphic user interfaces will be described with reference to FIG. 5, FIG. 6, and FIG. 7. However, the present invention is not limited thereto. The payment process information with priorities assigned might be provided to a consumer in other forms and methods.

FIG. 5 illustrates an example of providing initial payment process information in accordance with at least one embodiment.

Initial payment process information might be displayed within a graphic user interface displayed on input/output circuit 215 as a result of executing an application (e.g., credit card selection App) for a payment process management service. The initial payment process information might be generated after entering information on a consumer's payment processes and setting selection conditions of each payment process, as shown in FIG. 3. That is, the initial payment process information might be generated as a result of performing operations of FIG. 3.

Referring to FIG. 5, the initial payment process displayed within the graphic user interface includes priority 510 of each payment process, name 520 of each payment process, membership benefits 530 of each payment process, benefit requirements 540 of each payment process, user preferred membership benefits 550 of each payment process, and condition 560 for fulfilling benefit requirements. Name 520, membership benefits 530, and benefit requirements 540 might be obtained from payment information received from payment terminal 120 or directly from a server related to a merchant, a good or service to purchase, or each payment process. Priority 510, user preferred membership benefits 550, and condition 560 might be set by a consumer as selection conditions (e.g., S3070 of FIG. 3).

Furthermore, the graphic user interface might enable a consumer to add information of another payment process (e.g., 570) and to set up selection conditions of a selected payment process (e.g., 580).

Through the initial payment process information displayed as shown in FIG. 5, a consumer might be able to select one of the consumer's payment processes which can obtain the most benefits although user equipment 110 does not obtain additional information, such as membership benefit information and benefit requirement information, from service server 130 or payment process server 140.

FIG. 6 illustrates an example of a graphic user interface providing payment process information with priorities assigned based on membership benefit information and benefit requirement information associated with a merchant in consideration of selection condition information in accordance with at least one embodiment.

As described, user equipment 110 computes and assigns priorities of a consumer's payment processes based on the membership benefit information and the benefit requirement information (e.g., S4040 of FIG. 4), which might be received from service server 130. Based on the assigned priorities, user equipment 110 might update the initial payment process information and displays the updated payment process information as shown in FIG. 6. For example, the graphic user interface of FIG. 6 shows the updated payment process information when payment processes are credit cards and when a priority of a credit card is computed and assigned in consideration of a price discount set as a user preference benefit, and a required spending amount as a benefit requirement.

Referring to FIG. 6, the payment process information includes priority 610 of each credit card, name 620 of credit cards eligible to have a user preferred membership benefit set in selection condition, user preferred membership benefit 640 of each eligible credit card, benefit requirement 640 for having the user preferred membership benefit, and supplementary 650 information of each eligible credit card. In this case, a price discount is set as the user preferred membership benefit in corresponding selection conditions.

As shown in FIG. 6, a consumer is able to easily recognize which one of the consumer's credit cards is eligible to have preferred membership benefit and what is a requirement for having the preferred membership benefit. Furthermore, based on a priority of each eligible credit card, a consumer is able to easily select a credit card that provides the most membership benefit with the least requirement among the consumer's multiple credit cards. Since the first credit card offers the highest price discount rate (e.g., 10%) and the least requirement (e.g., $1,000 spending amount in three consecutive months), user equipment 110 assigns the first priority (e.g., 1) to the first credit card. The first priority (e.g., 1) might mean the first one to select. A value of the priority might be different. For example, a value of the priority of the first credit card might be higher than that of the second credit cards. That is, the value of the priority of the first credit card might 3 and the value of the priority of the second credit card might be 2. User equipment 110 might sort the credit cards based on the values of the priorities of the credit cards and display the credit card having the highest value on a top of others as the first priority to select.

As described, the graphic user interface of FIG. 6 might display the payment means information with the priorities assigned based on the membership benefit information and the benefit requirement information associated with a merchant. In accordance with at least one embodiment, user equipment 110 might consider information on a good or a service to purchase to assign a priority of each payment process and also provide such information through a graphic user interface for improving convenience of a consumer. Such graphic user interface will be described with reference to FIG. 7.

FIG. 7 illustrates another example of a graphic user interface providing payment process information with priorities assigned based on not only information associated with a merchant but also information associated with a good or a service to purchase in accordance with at least one embodiment.

As described, user equipment 110 might receive information on a good or a service to purchase from payment terminal 120. Such information might be included in the payment information transmitted from payment terminal 120 and include information on a price of the good to purchase. For example, when a consumer wants to buy a smart phone having a price of $100 dollars from a Pear store, user equipment 110 might receive such information on the price of the smart phone and the information on the Pear store from payment terminal 120 of the pear store.

User equipment 110 uses the information on the price of the smart phone to assign a priority of each eligible credit card and provides supplementary information that might help a consumer to choose a credit card to maximally obtain benefits thereof. For example, user equipment 110 provides information 730 on a price of the smart phone after a user preferred membership benefit applied (e.g., price discount), information 740 on a spending amount after buying the smart phone with a discounted price, and information 750 on a target spending amount that will fulfill the benefit requirement of each eligible credit card.

As shown in FIG. 7, since the first credit card is eligible to have 10% discount on the smart phone of the pear store, user equipment 110 calculates and displays the price after discount applied as $90 dollars. In case that a previous spending amount was $900 dollars, user equipment 110 calculates and displays the spending amount after buying the smart phone as $990 dollars. The consumer might buy the smart phone with the least price and might almost fulfill the benefit requirement if the consumer uses the first credit card to buy the smart phone from the Pear store. Accordingly, user equipment 110 assigns the first priority to the first credit card as shown in FIG. 7.

As described, the payment process information with priorities assigned is provided to a consumer through various types of graphic user interfaces and through various methods. The graphic user interfaces and information thereof shown in FIG. 5, FIG. 6, and FIG. 7 are only examples and the present invention is not limited thereto.

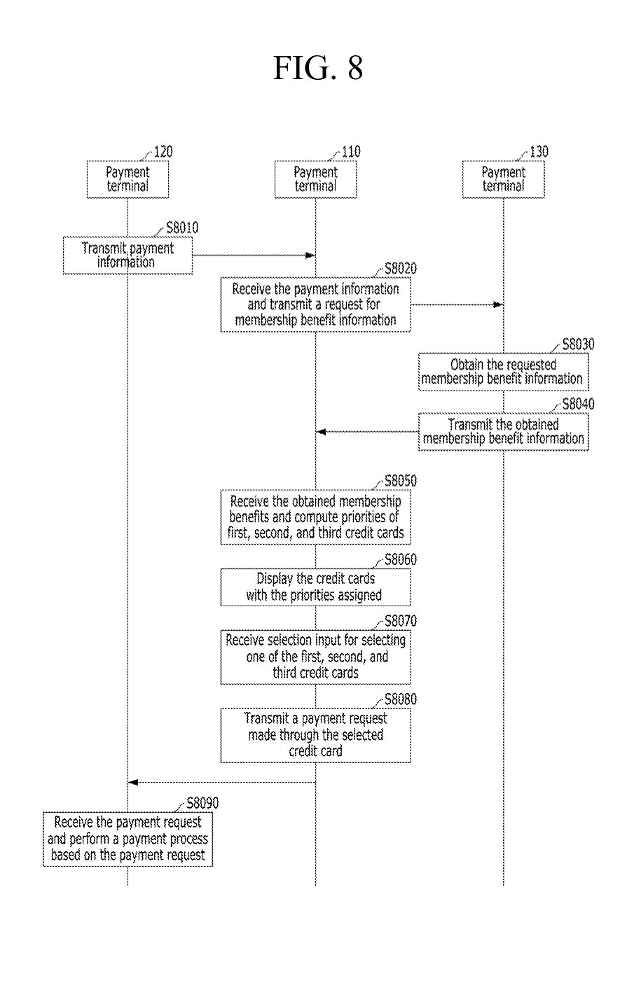

Hereinafter, operation of user equipment 110 for enabling a consumer to obtain maximum membership benefits of payment processes will be described based on an example of using credit cards as payment means with reference to FIG. 8. For convenience and ease of understanding, it assumes that a user (e.g., a consumer) of user equipment 110 registers first, second, and third credit cards at service server 130 through user equipment 110 or installs digital versions of the first, second, and third credit cards at user equipment 110. It further assumes that the user sets a discount rate as the first preference of member benefits and sets 1,000 dollar as the target spending amount for fulfilling associated benefit requirements by setting selection conditions of the three credit cards.

FIG. 8 shows an example of enabling a consumer to maximally obtain membership benefits of the consumer's payment processes through user equipment in accordance with at least one embodiment.

Referring to FIG. 8, payment terminal 120 transmits payment information of a smart phone named as “u-phone” to user equipment 110 when a consumer tries to buy the u-phone at a Pear store at step S8010. The payment information includes information on a merchant (e.g., Pear store) and a good (e.g., u-phone). Particularly, the payment information includes information on a price of the u-phone. Such payment information might be transmitted as a form of a text message to user equipment 110.

At step S8020, user equipment 110 receives the payment information from payment terminal 120 and transmits a request message for membership benefit information associated with the Pear store to service server 130 through communication network 150. The request message includes the payment information received from payment terminal 120. Particularly, the request message includes at least one of information on the u-phone price and the Pear store.

At step S8030, service server 130 obtains the requested membership benefit information of the consumer's each credit card corresponding to at least one of information on the u-phone price and the Pear store in response to the request. For example, the membership benefit information might include at least one of i) names of credit cards eligible to have the membership benefit associated with the Pear store and the u-phone, ii) a discount rate (or discount amount) of each eligible credit card, iii) indication whether bonus points will be required for having the membership benefit, iv) indication whether bonus points will be gained by buying the u-phone, and v) a previous spending amount of each credit card. At step S8040, service server 130 transmits the obtained membership benefit information to user equipment 110.

For example, service server 130 might obtain membership benefits information of the first credit card from a server (e.g., bank or company) associated with the first credit card. The obtained membership benefit information might indicate the first credit card is eligible to have 10% discount on the price of u-phone if the first credit card is used to buy the u-phone from the Pear store and if 1,000 dollars is spent using the first credit card in three consecutive months. Through the same way, service server 130 might obtain membership benefit information of the second credit card which indicates the second credit card is eligible to have 5% discount on the price of u-phone if the second credit card is used to buy the u-phone from the pear store and if 1,500 dollars is spent using the second credit card in three consecutive months. Similarly, service server 130 might obtain membership benefit information of the third credit card which indicates the third credit card is not eligible to have any benefit in the pear store or the u-phone.

At step S8050, user equipment 110 receives the obtained membership benefits of the eligible credit cards from service server 130 and computes priorities of the first, second, and third credit cards based on the received membership benefits and the selection condition set to each one of the first, second, and third credit cards.

As described, the consumer selects the discount rate as the first preference of the membership benefit and the target spending amount as the fulfill condition for the benefit requirements by setting the selection conditions of the first, second, and third credit cards, such selection conditions are considered to calculate priorities of the first to third credit cards with the membership benefits of each credit card.

At first, user equipment 110 calculates a discount price of the u-phone of each eligible credit card, for example, the first credit card and the second credit card. A regular price of the u-phone in the Pear store is $100 dollars. Accordingly, the discounted price of the u-phone is $90 dollars if the first credit card is used, or the discounted price of the u-phone is $95 dollars if the second credit card is used. Since the third credit card is not eligible to have membership benefit, the discounted price thereof is 100 dollar which is same as the regular price. As described, the price of the u-phone is received from payment terminal 120, but the present invention is not limited thereto. The price of the u-phone might be entered by the consumer through a predetermined user interface.

Secondly, user equipment 110 adds the discounted price of the u-phone with the previous spending amount and calculates a difference between the adding result and the target spending amount for each credit card. For example, when the discount price of the first credit card is 90 dollar and the previous spending amount is $910 dollars, the difference between the adding result and the target spending amount is 0 for the first credit card. When the discount price of the second credit card is $95 dollars and the previous spending amount is $1000 dollars, the difference between the adding result and the target spending amount is $405 dollars.

User equipment 110 assigns a priority of each credit card according to the calculated difference. For example, user equipment 110 assigns a higher priority to the first credit card than the second credit card because the first credit card has less difference than the second credit card. Furthermore, user equipment 110 assigns a lower priority to the third credit card than the first and second credit cards because the third credit card is not eligible to have membership benefit.

At step S8060, user equipment 110 displays the credit cards with the priorities assigned. For example, user equipment 110 displays the first credit card with the priority of 3, the second credit card with the priority of 2, and third credit card with the priority of 1.

At step S8070, user equipment 110 receives a selection input from the consumer. For example, user equipment 110 receives a selection input for selecting the first credit card from the consumer because the first credit card has the highest priority. That is, the first credit card will return the most benefit if the consumer uses the first credit card to buy the u-phone from the pear store.

At step S8080, user equipment 110 transmits a payment request to payment terminal 120 based on the selection input. For example, user equipment 110 transmits a payment request to make a payment using the first credit card since user equipment 110 receives the selection input for selecting the first credit card to buy the u-phone from the Pear store.

At step S8090, payment terminal 120 receives the payment request from user equipment 110 and performs a payment process with the first credit card in cooperation with a related payment server through communication network.

That is, payment terminal 120 might request a payment server associated with the first credit card to process a payment made through the first credit card to buy the u-phone from the pear store.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of user equipment for managing a plurality of payment processes belonging to a consumer to obtain associated membership benefits, the method comprising:
computing a corresponding priority for each of the plurality of payment processes based on at least one of membership benefit information associated with a merchant, associated benefit requirement information, and selection condition information of the plurality of payment processes;
assigning the computed priorities to the corresponding payment processes; and
providing information on the plurality of payment processes with the assigned priorities to the consumer through a user interface displayed through an input/output circuit of the user equipment as a result of executing an application associated with the payment process and resident in the user equipment,
wherein the priority assigned to a payment process indicates a measure of a membership benefit returned by employment of the payment process when the consumer uses the payment process to make a payment for a purchase of a good or a service from the merchant.

2. The method of claim 1, comprising:
receiving a selection input corresponding to a selection of one of the plurality of payment processes from a user based on the assigned priorities of the plurality of payment processes; and
transmitting a payment request with information on the selected payment process to make a payment for a purchase of a good or a service from the merchant.

3. The method of claim 1, comprising:
selecting, by a processor of the user equipment, one payment process assigned with a priority that indicates a maximum membership benefit returned to the consumer among the plurality of payment processes; and
transmitting a payment request with information on the selected payment process.

4. The method of claim 1, prior to the computing, comprising:
receiving information on the merchant from a merchant device upon a predetermined event;
requesting the membership benefit information and the benefit requirement information, based on the received information on the merchant, from at least one of a service server coupled to the user equipment through a communication network, the merchant device, and a server associated with one of the merchant and each payment means of the consumer; and
receiving the membership benefit information and the benefit requirement information from the at least one of the service server, the device of the merchant, and the server.

5. The method of claim 4, wherein the predetermined event is one of:
entering a predetermined area of the merchant;
receiving a predetermined signal from the merchant device; and
scanning a good or a service to be purchased from the merchant.

6. The method of claim 1, prior to the computing, comprising:
scanning a code pattern image posted at a certain area of the merchant;
decoding the scanned code pattern image into information on the merchant;
requesting the membership benefit information based on the information on the merchant to at least one of a service server coupled to the user equipment through a communication network, the device of the merchant, and a server associated with one of the merchant and each payment process of the consumer; and
receiving the requested membership benefit information from the at least one of the service server, the device of the merchant, and the server.

7. The method of claim 1, prior to the computing, comprising:
scanning a code pattern image posted at a certain area of the merchant; and
decoding the scanned code pattern image into membership benefit information and benefit requirement information associated with the merchant.

8. The method of claim 1, prior to the computing, comprising:
detecting information on the plurality of payment processes based on information stored in the user equipment;
providing the detected payment process information to the consumer through a user interface generated displayed through an input/output circuit of the user equipment as a result of executing an associated application stored in the user equipment;
receiving set-up inputs, through the displayed user interface, corresponding to settings for selection conditions of the plurality of payment processes of the consumer;
setting at least one of a user assigned priority, a user preferred membership benefit, and a target condition for satisfaction of an associated benefit requirement as the selection conditions of each one of the plurality of payment processes; and
storing results of the set selection conditions in connection with the plurality of payment processes.

9. The method of claim 8, comprising:
receiving information on at least one of the plurality of payment processes from the consumer through the user interface.

10. The method of claim 8, wherein the plurality of payment processes are at least one of:
a payment process registered through the user equipment;
a payment process digitally installed in the user equipment by downloading a digital version corresponding to the payment process from an associated server and installing the downloaded digital version; and
a payment process issued from an associated server through the user equipment.

11. The method of claim 1, wherein the computing comprises:
selecting, from the plurality of payment processes of the consumer, each eligible payment process able to return membership benefits associated with the merchant based on at least one of the information on the merchant and the membership benefit information;
applying a predetermined value to the corresponding priorities of the selected eligible payment processes;
selecting, from one or more of the eligible payment processes, a preferred payment process able to return a membership benefit preferred by the consumer based on the selection condition information;
determining associated benefit requirements of the preferred payment process based on the selection condition and sorting the preferred payment processes in an ascending order from the preferred payment process having a lowest degree of the determined benefit requirements to a highest degree of the determined benefit requirements;
applying different values decreasing in a descending order to corresponding priorities of the sorted preferred payment processes,
wherein one preferred payment process having a priority with a largest value returns the most membership benefit among the preferred payment processes if the consumer uses the one preferred payment process to make a payment to purchase a good or a service from the merchant.

12. A method for managing, by user equipment, a plurality of credit cards belonging to a consumer to obtain maximum membership benefits, the method comprising:
obtaining payment information on a purchase from a payment terminal of the merchant when the purchase is scanned by the payment terminal, wherein the payment information includes information on the purchase and the merchant;
including the obtained payment information in a request message when requesting membership benefit information associated with the merchant, transmitting the request message to a service server, and receiving the requested membership benefit information from the service server;
computing priorities of the plurality of credit cards based on the received membership benefit information and selection condition information of the plurality of credit cards and assigning the computed priorities to the plurality of credit cards; and
providing information on the plurality of credit cards with the assigned priorities to the consumer through a user interface displayed through an input/output circuit of the user equipment as a result of executing an associated application stored in the user equipment,
wherein the priorities of the plurality of credit cards indicate a measure of a membership benefit returned by a respective payment process when the respective payment process is used to make a payment for the purchase.

13. The method of claim 12, prior to the obtaining, comprising:
providing information on credit cards belonging to the consumer through a user interface displayed through an input/output circuit of the user equipment when executing an associated application stored in the user equipment;
receiving a selection input of at least one of the plurality of credit cards and receiving set-up inputs for settings of selection conditions of the selected credit cards from the consumer through the displayed user interface;
setting the selection conditions of the selected credit card based on the selection input and the set-up inputs; and
storing results of the setting of the selection conditions as the selection condition information of the selected credit card.

14. The method of claim 12, wherein when a price discount rate is set as a user preferred membership benefit and a predetermined target spending amount is set as a target condition for fulfilling benefit requirement as the selection condition information, the computing comprising:
for each one of the plurality of credit cards, obtaining a price discount rate of each credit card as the user preferred membership benefit, calculating a price of the purchase after the obtained price discount rate is applied, adding the calculated price with a previous spending amount, and calculating a difference between the adding result and the target spending amount by subtracting the adding result from the target spending amount;
storing the plurality of credit cards in a an ascending order based on the calculated difference of each credit card; and
assigning corresponding priorities having descending values to the sorted credit cards.

15. The method of claim 14, the computing comprising:
assigning a lowest priority to a credit card when the credit card has the previous spending amount higher than the target spending amount.

16. The method of claim 14, when more than two credit cards have the same differences, the computing comprises:
assigning a lower priority to one requiring a predetermined amount of reward points for using a membership benefit than priorities assigned to others not requiring the predetermined amount of reward points; and
assigning a higher priority to one credit card gaining a predetermined amount of reward points although a membership benefit is used for making a payment than to credit cards having priorities assigned not gaining the predetermined amount of reward points.

17. The method of claim 12, comprising:
receiving a selection input as a selection of one of the plurality of credit cards, the selection made by the consumer based on the assigned priorities of the plurality of credit cards; and
transmitting a payment request with information on the selected credit card to make a payment for the purchase.

18. User equipment for managing a plurality of payment processes belonging to a consumer to obtain maximum membership benefits, the user equipment configured to:
receive payment information associated with a merchant and a purchase from a merchant device when the purchase is scanned by the device;
request membership benefit information and benefit requirement information associated with the merchant based on the received payment information to a service server coupled to the user equipment through a communication network and receive the membership benefit information and the benefit requirement information from the service server;
compute, by a processor of the user equipment, priorities of the plurality of payment processes based on the received membership benefit information, the received benefit requirement information, and selection condition information and assign the computed priorities to the plurality of payment processes; and
provide information on the plurality of payment processes with the assigned priorities through a user interface displayed through an input/output circuit of the user equipment as a result of executing an associated application stored in the user equipment,
wherein a priority of a payment process indicates a degree of a membership benefit returned by the payment process when the consumer uses the payment process to make a payment for the purchase from the merchant.

19. The user equipment of claim 18, wherein the user equipment is configured to:
receive a selection input for selecting one of the plurality of payment processes, which is made by the consumer based on the assigned priorities of the plurality of payment processes; and
transmit a payment request with information on the selected payment process to make a payment for the purchase to the device.

20. The user equipment of claim 18, wherein the user equipment is configured to:
detect information on the plurality of payment process based on information stored in a memory of the user equipment;
provide the detected payment process information to the consumer through the user interface;
receive set-up inputs, through the user interface, for setting selection conditions of the plurality of payment processes from the consumer;
set at least one of a user assigned priority, a user preferred membership benefit, and a target condition for fulfilling an associated benefit requirement as the selection conditions of each one of the plurality of payment processes; and
store results of setting as the selection condition information in connection with the plurality of payment processes.
